(19) United States
(12) Patent Application Publication
(10) Pub. No.: US 2018/0239582 A1
(43) Pub. Date: Aug. 23, 2018

(54) Mobile Virtual Assistant Device

(71) Applicant: Frank Goss, III, Chicago, IL (US)

(72) Inventor: Frank Goss, III, Chicago, IL (US)

(21) Appl. No.: 15/441,147

(22) Filed: Feb. 23, 2017

(51) Int. Cl. G06F 3/16

(52) U.S. Cl. CPC G06F 3/167; H04M 1/72519

(57) ABSTRACT

A Mobile Virtual Assistant Device (MVAD) is the size and shape of a standard political button (available in multiple shapes not necessarily round) with a voice/conversational interface. MVAD uses voice and interactive conversation to execute commands, tasks, and access files—things traditionally done by touch; typing, clicking or tapping. The mobile virtual assistant device is bigger than a smartwatch and smaller than a smartphone. It is a new category of mobile devices in the mobile smartphone, tablet and smartwatch industry which use voice and conversational interface with a virtual assistant. MVAD uses standard cell phone wireless networks and connections (same as smartphones); AT&T, Verizon, T-Mobile, Sprint and others. The Mobile Virtual Assistant Device can be worn similar to a political button or with a chain (similar to a necklace, medallion, or pendant) or use magnets clasp which attach the device to your clothing or carried in variety other ways. The MVAD is a mobile virtual assistant on the go; it allows you to take your virtual assistant functionality everywhere you go.

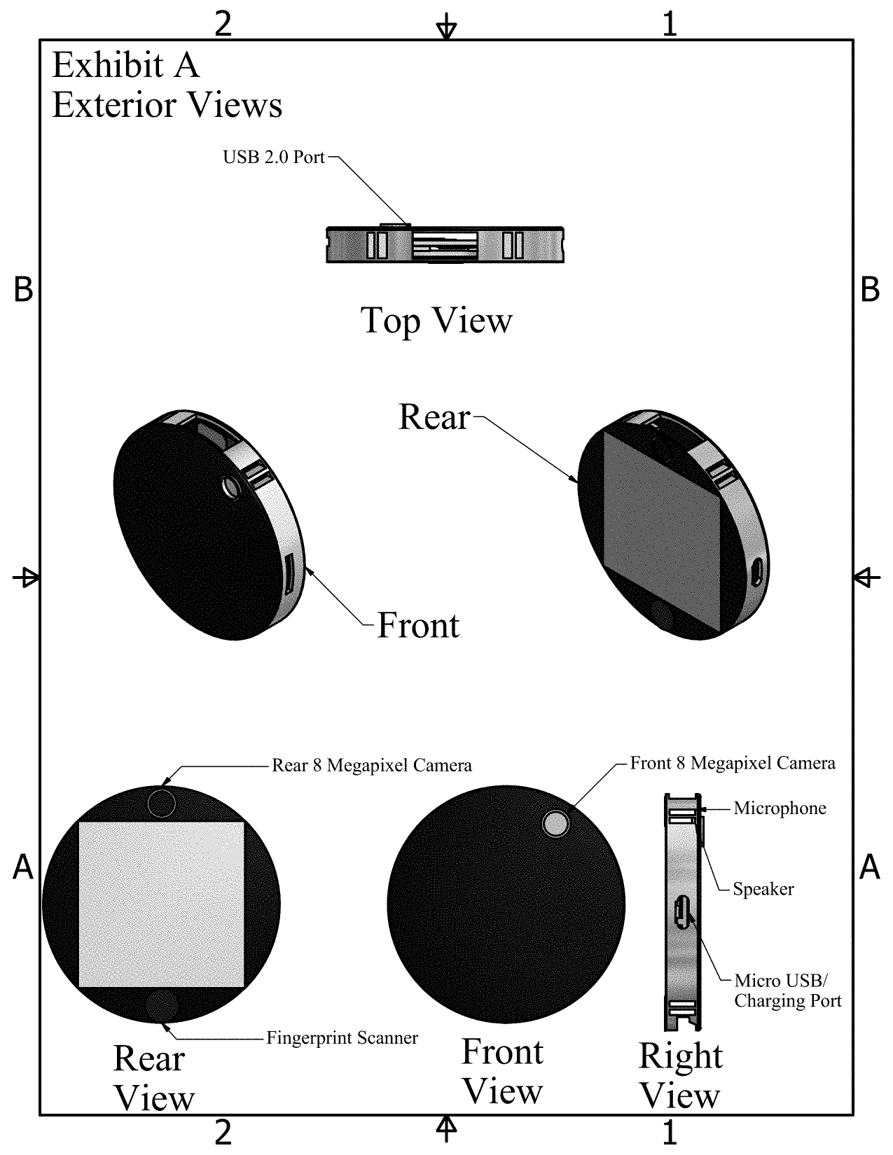

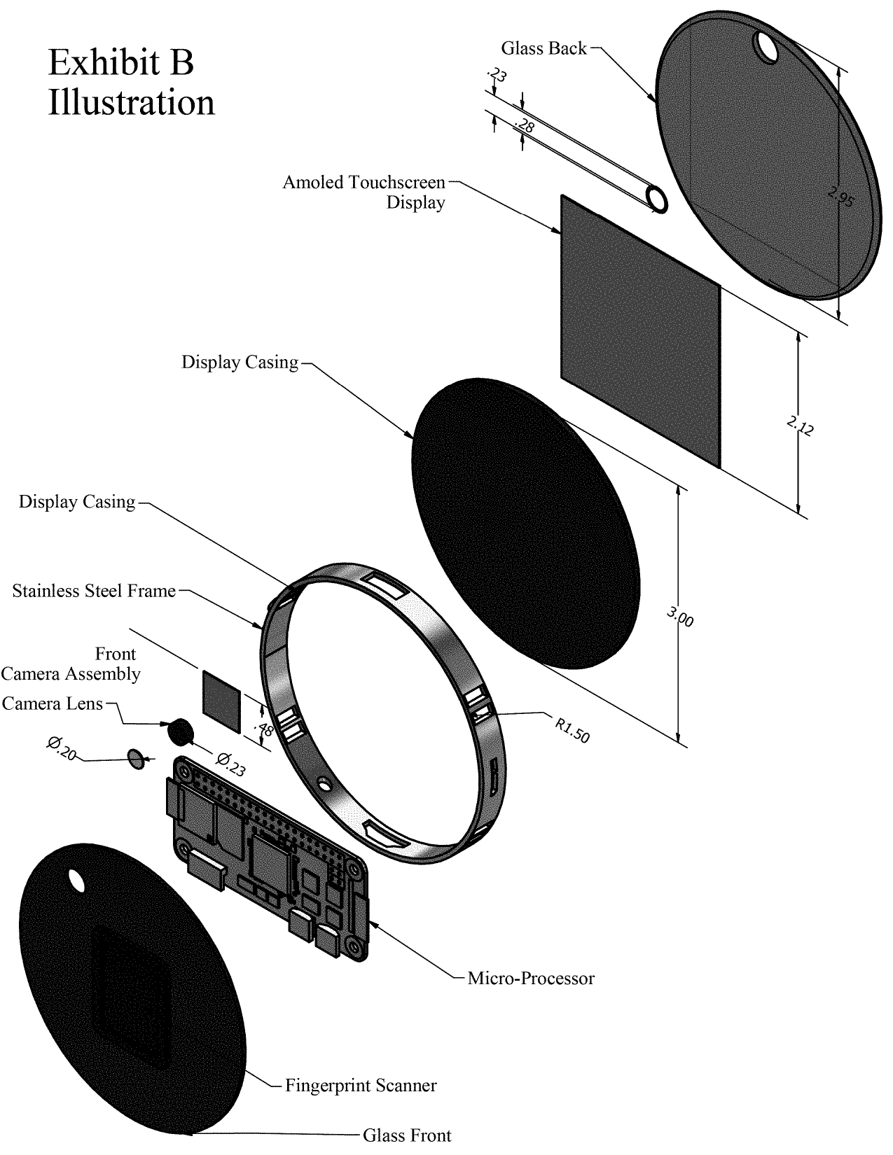

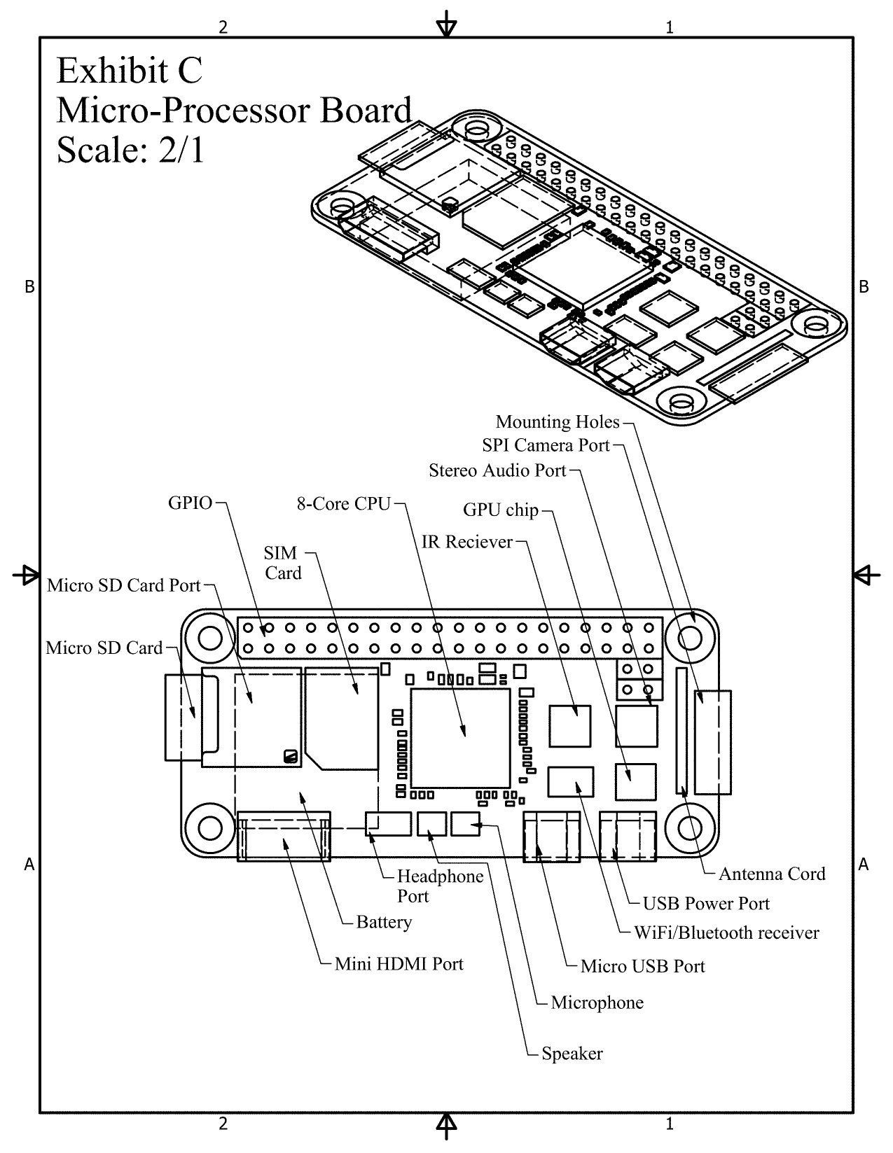

### BRIEF SUMMARY OF THE INVENTION

### Front of Device

### Mobile Virtual Assistant Device

The Mobile Virtual Assistant Device (MVAD) is a device a person can carry the size of a political button which features voice/conversation as the primary user interface. A voice-User interface (VUI) makes human interaction with computer possible through a voice/speech platform in order to initiate an automated service, process or completion of a task. The virtual assistant of choice (selected by the owner of the device; Siri, Google Assistant, Cortana, Alexa, Bixby etc. . . . ) performs all of the commands and tasks a smartphone does by using voice commands and conversation with a virtual assistant Cloud base voice/speech platform (example companies with voice/speech Cloud Platforms—Google, Samsung, Microsoft, Apple, IBM, Amazon etc. . . . ). The Mobile Virtual Assistant Device is a replacement or substitute for a smartphone, tablet or smartwatch. MVAD use standard cell phone wireless networks and connections (same as smartphones; AT&T, Verizon, T-Mobile, Sprint and others). Smartphone are devices which use touch screens as their interface and the Mobile Virtual Assistant Device use voice/conversation/VUI as the interface. The MVAD is a Mobile Virtual Assistant on the go; it allows you to take your Virtual Assistant everywhere you go, and use it to make phone calls, emails, text messaging, accessing files etc. . . . , everything you would do by touch, typing, click or tap—you do by voice commands and conversation

### Back of Device

### Smartphone

Access to a standard smartphone, the size of a political button, is on the reverse of the MVAD. The touchscreen smartphone serves as a backup for users when their selected Virtual Assistant cloud based platforms i.e. voice/speech, have limited ecosystems and lack the specific functionality desired. All Virtual Assistant ecosystems are at various stages of development and functionality, and may lack certain skills or software development, and therefore are unable to execute the more complex voice commands requested. In these cases the user can revert to the touch screen on the back of the MVAD to complete the task.

### DETAILED DESCRIPTION OF THE INVENTION

The Mobile Virtual Assistant Device (MVAD) is a device the size of a standard political button. It is round (see drawings), square or a variety of shapes with a biometric finger print on the back of the device which give you the option to activate MVAD by voice command or one finger touch. At the top of the MVAD are microphones slots and speaker slots that are used for communication with the voice interface software produced by the virtual assistant of choice you select. MVAD can be activated by voice commands or biometric finger print in the center of the MVAD device. An individual can select and use their virtual assistant of choice (Amazon/Alexa, Apple/Siri, Microsoft/Cortana, Samsung/Viv etc. . . . ) to migrate to the MVAD device. The MVAD will accommodate any manufacture virtual assistant voice interface. The Mobile Virtual Assistant Device defines a new category or space in the mobile smartphone industry where people can now travel with a device which primary interface is a voice/conversational interface verse touch screen which is standard for smartphones, smartwatches and tablets. The MVAD is manufactured with a micro-circuit board which uses a CPU with cores that support Tensorflow, neural networks, natural language processors, machine learning and artificial intelligence and chatbot libraries (see circuit board diagram drawing—835 Snapdragon/Qualcomm or more advance chip). Random Access Memory for voice/conversation will be utilized to store past commands (intents) and allow the CPU to recall intents faster. In cases where Ram is not used the Cloud Platform for the virtual assistant will perform the task. MVAD uses standard cell phone wireless networks and connections (same as smartphones); AT&T, Verizon, T-Mobile, Sprint and others.

### BRIEF DESCRIPTION OF DRAWINGS

1. Exhibit A—The Mobile Virtual Assistant Device (MVAD)—front, back, top, bottom and sides

2. Exhibit B—The MVAD-diagram of the different layers; a layer by layer view

3. Exhibit C—The circuit board schematic identifying key components

1. A Mobile Virtual Assistant Device (MVAD) is a mobile device which a user operates by a voice and conversational interface (VUI—Voice User Interface). The MVAD is worn as a necklace pinned to the user's clothing or carried. The user speaks to the MVAD via the Voice User Interface, to perform commands, intents, actions, or tasks. The MVAD VUI executes the requested commands intents, or actions, by transferring the voice input to the chosen virtual assistant's cloud infrastructure which executes the request and sends the response back to the MVAD in the form of a conversational reply, indicating successful completion or not. Physical interactions with the MVAD (touch, typing, click etc.) are not required. The MVAD is designed to utilize the full extent of the virtual assistant's capabilities through the VUI, as with the proprietary system.

2. The MVAD device can be round, square or other shapes, it is approximately the size of a typical political button. It can be attached to clothing, worn as a necklace or pendant, or placed in clothing pockets or purses and briefcases.

3. A mobile device to which a person can migrate their virtual assistant of choice and its cloud platform to the device. The device is compatible with any virtual assistant such as, Siri, Google Assistant, Cortana, Alexa, Bixby etc. The MVAD can only operate one virtual assistant eco-system at a time, but the user can decide to remove one virtual assistant system and migrate to another (like switching mobile carriers).

4. The MVAD is manufactured with a micro-circuit board which uses a CPU with cores that support Tensorflow, neural networks, natural language processors, machine learning, deep learning, and artificial intelligence and chatbot libraries (see circuit board diagram drawing). The GPU supports the CPU by performing some of the computations required by the natural language processors, neural networks, deep learning, artificial intelligence, cloud platform, software stacks of the virtual assistant of choice (Alexa, Bixby, Google Assistant, Cortana, etc.) The device has Random Access Memory (RAM) for voice/conversation, and the RAM can be utilized to store past commands (intents) and allow the CPU to recall intents faster. In cases where RAM is not used, the Cloud Platform for the virtual assistant will perform the task. MVAD uses standard cell phone wireless networks and connections; such as AT&T, Verizon, T-Mobile, Sprint and others.

5. Random Access Memory (RAM) for voice/conversation will provide storage and retrieval for voice and conversational commands (intents) previously given to the mobile virtual assistant device.

6. MVAD uses standard cell phone wireless networks and connections; such as AT&T, Verizon, T-Mobile, Sprint, WiFi, Bluetooth and others.

7. MVAD voice/conversation interface will enable the user to instruct his/her virtual assistant to performs tasks such as place telephone calls, text messaging, send and receive e-mail messages, web search and web browsing, take pictures, access and interact with apps, interact and communicate with other electronic devices, etc.

8. MVAD would also allow the user to direct his/her virtual assistant to perform tasks in the home office, business, corporate and enterprise organizations. These functions depend on whether the virtual assistant eco-system that is migrated to the MVAD supports such commands.

9. MVAD is a new product category in the mobile devices space. MVAD is a device which specializes in the mobile virtual assistant space: where a user can take their virtual assistant of choice anywhere they might travel. Because it commodifies access to virtual assistant technologies, it represents a new platform in the mobile devices universe. All other virtual assistant ecologies feature proprietary hardware (e.g. smarthome, Echo, and Google Home) and an infrastructure of accessible commands specific to that product. The MVAD permits a user to be untethered from the basic “at home” context, and the narrow, primary use case promoted by manufacturers, of simply “commerce”. Because it is always present, the most frequent uses of the device expand from “buy eggs” to a greater integration into the functional lives of the users.
